(19) United States
(12) Patent Application Publication
(10) Pub. No.: US 2003/0053004 A1
(43) Pub. Date: Mar. 20, 2003

(54) Projection television having cooling fan with noise attenuation

(75) Inventor: Seok-il Yoon, Daejeon-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/164,573

(22) Filed: Jun. 10, 2002

(30) Foreign Application Priority Data
Sep. 18, 2001 (KR) 2001-57650

(51) Int. Cl. H04N 5/74

(52) U.S. Cl. 348/748

(57) ABSTRACT

A projection television which can reduce noise generated in a cooling fan for cooling an internal high temperature heat. The projection television includes: a lamp for providing a light source; a circuit driving unit for supplying electric power; a cooling fan for cooling heat generated in the lamp and the circuit driving unit; a duct for inducing an air drawn in by the cooling fan and for externally discharging the air; and a resonator installed on the duct, for removing noise generated by the cooling fan. Accordingly, the projection television reduces the noise generated by the cooling fan, and removes the noise generated by other factors by adjusting a number of the resonators.

### BACKGROUND OF THE INVENTION

1. Field of the Invention

The present invention relates to a projection television and, more particularly, to a projection television having an improved cooling structure to reduce noise generated in a cooling fan for cooling an internal high temperature heat.

The present application is based on Korea Application No. 2001-57650, filed Sep. 18, 2001, which is incorporated herein by reference.

2. Description of the Related Art

In general, a television using a cathode ray tube as a screen requires a large-size cathode ray tube to enlarge the screen. However, there are technical difficulties in the fabrication of the large-sized cathode ray tube. Moreover, such a large-sized cathode ray tube has an increased weight, which causes other problems in the fabrication of a television set.

A projection television has been suggested to embody a large-size screen by solving the foregoing problems. Generally, a liquid crystal display (LCD) projection television uses a principle that a strong optical beam, from a lamp, projects a television image displayed on the LCD to the screen, passing the LCD.

FIG. 1 is a schematic diagram illustrating a related LCD projection television set, and FIG. 2 is a diagram illustrating an optical system of an engine unit of FIG. 1. Referring to FIGS. 1 and 2, the engine unit 12 of the LCD projection television set 10 includes the optical system composed of a lamp 18, an LCD panel 20 and a projection lens 22.

The optical beam from the high output lamp 18 is transmitted to the LCD panel 20 through the predetermined optical system. The LCD panel 20 projects an incident light from the lamp 18 in response to an inputted television image signal. The projection lens 22 enlarges a television image transmitted from the LCD panel 20. A mirror 14 completely reflects the image from the engine unit 12, namely the projection lens 22, and projects the image to a screen 16, so that the television image can be displayed on the screen 16. For this, the engine unit 12 is installed in the television set 10, maintaining a predetermined angle from the mirror 14. In this case, the general LCD device is weak in heat, and thus, its endurance temperature is about 50° C. Accordingly, it is necessary to forcibly cool the LCD device by using a fan. In order to cool the high output lamp and the LCD device, which is weak in heat, at least two fans are provided in the LCD projection television.

FIG. 3 is a side diagram illustrating the related projection television having a cooling fan. As shown in FIG. 3, the fan 24, connected to the engine unit 12, in the LCD projection television set 10, sucks in an external low temperature air to cool the LCD panel. For this, the fan 24 is installed at a curved portion of the engine unit 12 in order to be adjacent to the LCD panel. The external air is sucked in through an air inlet 26 positioned on the front surface of the television set 10, namely the lower portion of the screen 16. Still referring to FIG. 3, the air inlet 26 is mounted on a printed circuit board (PCB) and is aligned in front of the engine unit 12, and the fan 24 is aligned behind the engine unit 12. A dust net (not shown) is adhered to the air inlet 26 to remove dust from the external air. When the dust from the externally-sucked air appears on the LCD panel, it is projected to the screen 16. The air sucked in through the air inlet 26 is transmitted to the LCD panel through a passage device (not shown). The passage device forms a passage of the air sucked in through the air inlet 26. Also, the passage device controls the air, which is purified through the dust net, so that it reaches the LCD panel.

However, the related projection television has a disadvantage in that the cooling fan 24 generates serious noise. In addition, noise is generated when the air collides with the surrounding structure.

### SUMMARY OF THE INVENTION

Accordingly, it is an aspect of the present invention to provide a projection television which can efficiently attenuate noise generated in a cooling fan, and a method of doing this.

To achieve the above aspect, the present invention includes a projection television that has a lamp for providing a light source; a circuit driving unit for supplying electric power; a cooling fan for cooling heat generated in the lamp and the circuit driving unit; a duct for inducing an air drawn in by the cooling fan and for externally discharging the air; and a resonator installed on the duct, for removing noise generated by the cooling fan.

The resonator removes the noise by resonating at a frequency, which is obtained by multiplying a number of revolutions of the cooling fan per unit time by a number of blades of the cooling fan.

The projection television further includes at least one auxiliary resonator for removing noise by resonating the frequency that corresponds to aninteger multiple of the calculated frequency.

The duct is formed in a tube shape, and comprises an inlet unit through which the air that passes the lamp and/or circuit driving unit, can be sucked, and an outlet unit for externally discharging the air.

The projection television further includes at least one friction noise resonator for resonating at a frequency corresponding to a friction noise generated by the friction of the air and the duct. This noise resonator is located on the duct for the purpose of removing the friction noise.

The method for removing the noise will be outlined as follows. First, a noise frequency of a cooling fan is calculated by multiplying a number of revolutions per unit of time by a number of blades in the cooling fan. Second, an intrinsic frequency of the resonator is calculated by using a spring and a mass, by applying the formula of:

$$ω = \sqrt{\frac{{C}^{2} S}{{L}^{′} V}}$$

wherein, C denotes a sound velocity, S denotes a section of a neck of the resonator, L′ denotes an equivalent length of the neck of the resonator connected by a flange, and V denotes a bulk of the resonator. Third, a resonator located on a duct resonates at an intrinsic frequency equivalent to a peak value of the noise frequency. The method further includes using a plurality of the resonators, which can resonate at different frequencies to remove a number of noises.

Accordingly, the present invention can reduce not only the noise generated in the cooling fans themselves, but also the friction noise generated by the induction of the air in the duct.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram illustrating a general projection television set;

FIG. 2 is a diagram illustrating an optical system of an engine unit of FIG. 1;

FIG. 3 is a side diagram illustrating a related projection television having a cooling fan;

FIG. 4 is a schematic diagram illustrating a projection television in accordance with the present invention;

FIG. 5 is a schematic diagram illustrating a lamp, a cooling fan and a duct of FIG. 4;

FIG. 6 is a graph showing a sound spectrum of the cooling fan's noise;

FIG. 7 is a diagram illustrating the structure of FIG. 5 with a resonator;

FIG. 8 is a diagram illustrating attenuation of noise by the resonator of FIG. 7;

FIG. 9 is a diagram illustrating the sound spectrum having a peak value removed by the resonator of FIG. 7; and

FIG. 10 is a diagram illustrating the structure of FIG. 5 having a plurality of resonators.

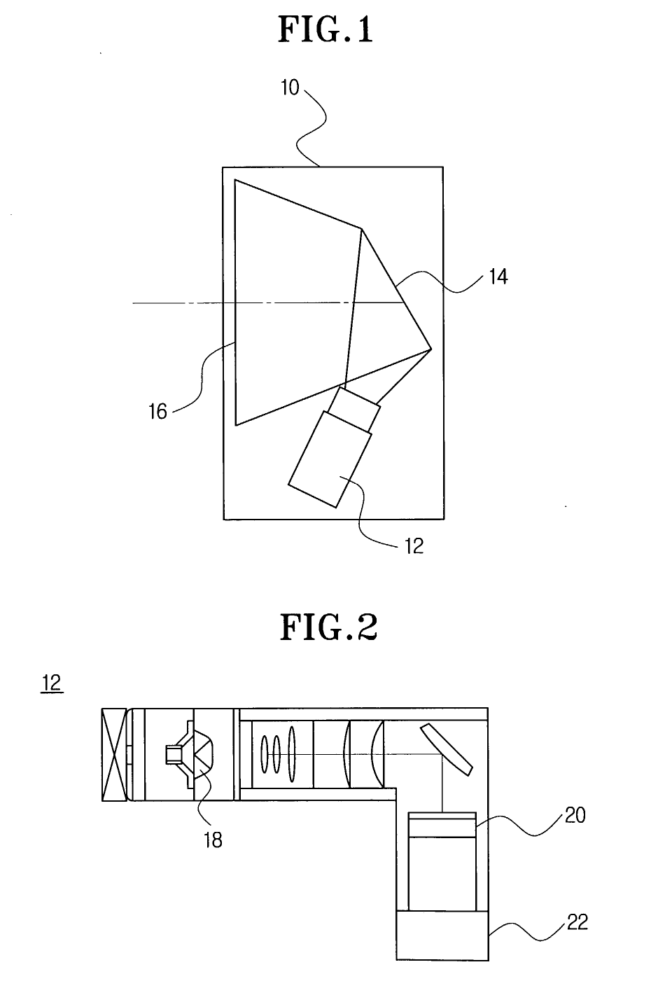

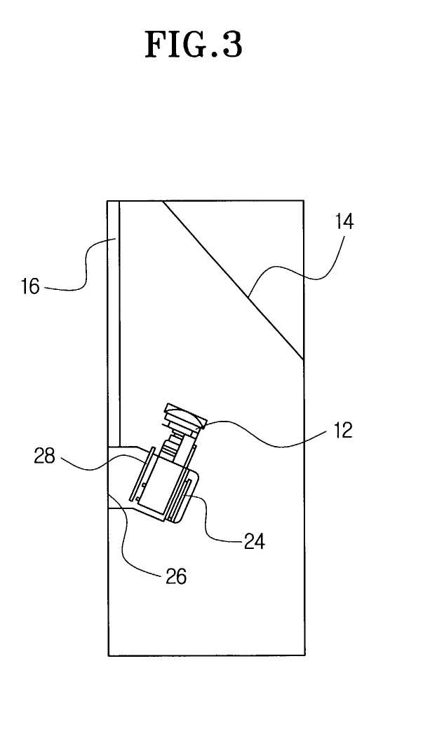

### DETAILED DESCRIPTION OF THE ILLUSTRATIVE EMBODIMENTS

A projection television in accordance with illustrative and non-limiting embodiments of the present invention will now be described in detail with reference to the accompanying drawings.

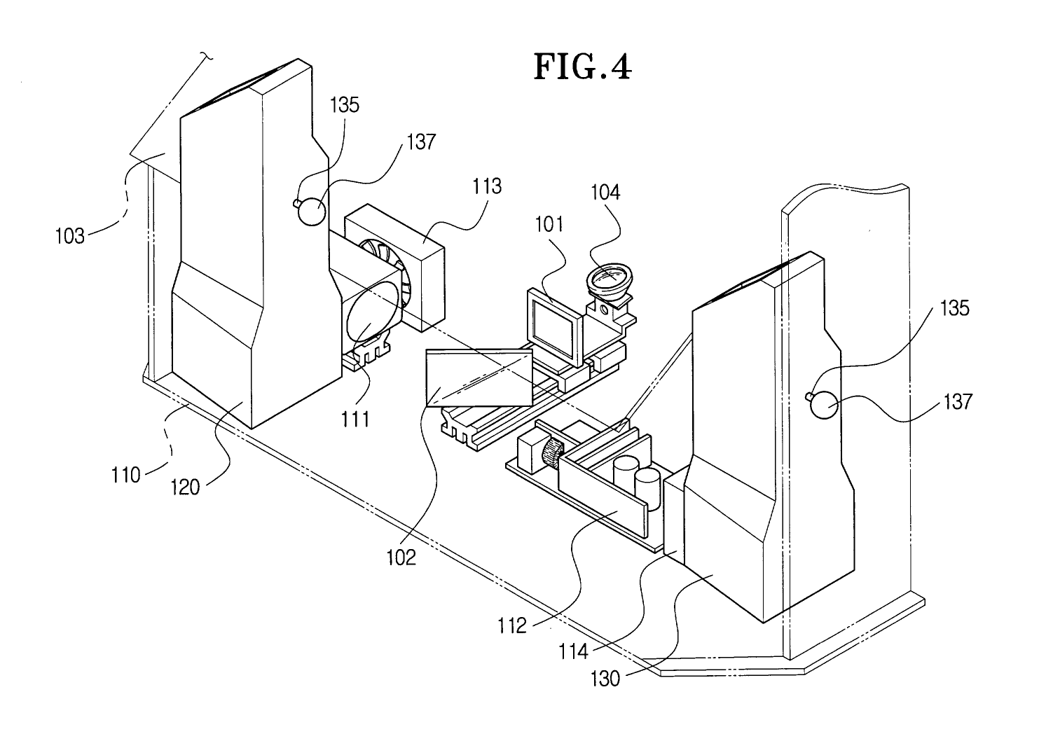

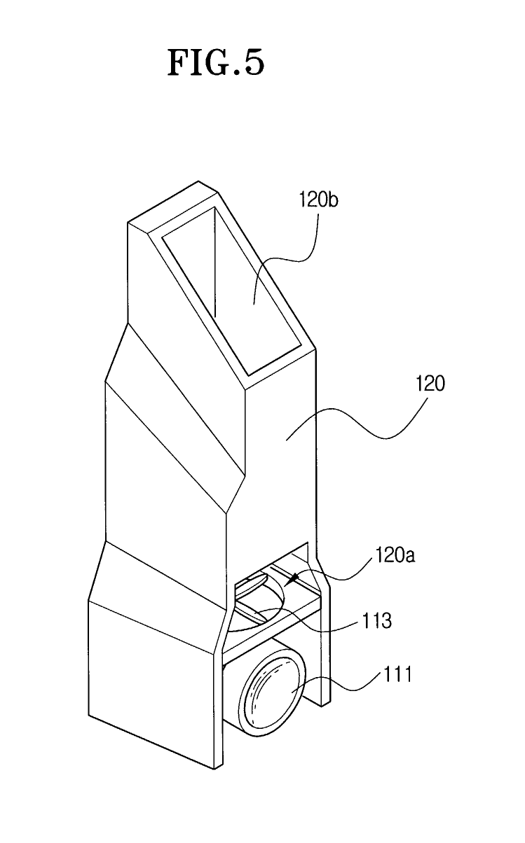

FIG. 4 is a schematic diagram illustrating the projection television in accordance with the present invention. Referring to FIG. 4, a lamp 111 for providing a light source and a circuit driving unit 112 for supplying electric power to the projection television are separately aligned in the projection television. An optical separation/composition system including an image display 101, reflecting mirrors 102 and 103 and a projection lens 104 is positioned between the lamp 111 and the circuit driving unit 112. In addition, two cooling fans 113 and 114 are positioned near the lamp 111 and the circuit driving unit 112 in order to cool the heat generated from the lamp 111 and the circuit driving unit 112. The cooling fans 113 and 114 are installed at the lower portion of a rear wall of a housing 110 that faces a screen (S), at any location that is adjacent to the lamp 111 and the circuit driving unit 112, respectively. Ducts 120 and 130, which are responsible for externally discharging the air sucked in by the cooling fans 113 and 114, are provided so that the air generated by the cooling fans 113 and 114 can be discharged through the lamp 111 and the circuit driving unit 112. As depicted in FIG. 5, the ducts 120 and 130 preferably surround the lamp 111 and the circuit driving unit 112 so as to prevent the heat generated by the lamp 111 and the circuit driving unit 112 from being leaked to other units. A resonator 137 for removing noise generated by the cooling fans 113 and 114 is located on the ducts 120 and 130. The resonator 137 is an apparatus for reducing noise by resonance of a specific inlet/outlet frequency. Especially, a spherical chamber having a shorter neck and a smaller bulk than an object frequency is called a Helmholtz resonator. In the present case, the air of the neck is operated as a mass, and a bulk of the tube and a section of the neck are operated as a spring. An intrinsic frequency is determined by the mass and the spring. When adhered to a predetermined system, the resonator serves to reduce the sound of the intrinsic frequency. In the present case, the intrinsic frequency is represented by the following Formula 1:

$$ω = \sqrt{\frac{{C}^{2} S}{{L}^{′} V}} \qquad \text{<Formula 1>}$$

wherein, C denotes a sound velocity, S denotes a section of a neck 135 of the resonator 137, L′ denotes an equivalent length of the neck 135 of the resonator 137 connected by a flange 135a, and V denotes a bulk of the resonator 137. In addition, when the flange 135a is disposed at the outer neck portion of the resonator 137, ‘L’=L+1.7a′ is satisfied (L denotes a length of the neck 135 of the resonator 137, and a′ denotes a radius of the neck 135 of the resonator 137). On the other hand, when the flange 135a is not provided to the outer neck portion of the resonator 137, ‘L’=L+1.5a′ is satisfied.

The shape of the resonator 137 does not influence the resonance frequency. That is, when resonators of different shapes have the same volume, the same length of the neck and the same surface area, the resonators have the same resonance frequency.

The surrounding structure of the lamp 111 will now be explained. The duct 120 includes: an inlet unit 120a through which the air passing the lamp 111 is inhaled; and an outlet unit 120b connected to an air vent (not shown) formed on the housing 110, for discharging the inhaled air. The inlet unit 120a is positioned near the lamp 111, so that the air passing the lamp 111 can be directly inhaled therethrough. In this embodiment, the duct 120 installed adjacently to the lamp 111 was exemplified, but the duct 130 installed adjacently to the circuit driving unit 112 has the same constitution and operation.

The cooling fans 113 and 114 have an air flow rate per time in a special number of revolutions. It is very important to maintain the air-flow rate per time in cooling. Actually, the air-flow rate per time becomes a function of the special number of revolutions of the fan. Moreover, the number of revolutions of the fan per unit time and a number of blades of the fan are important design factors of a sound spectrum of the fan with respect to noise. A noise frequency calculated by the number of revolutions of the fan per unit time and the number of the blades of the fan is represented by the following Formula 2:

<Formula 2>

Noise Frequency=N(rpm)×k/(60 sec)

wherein, N denotes a number of revolutions of the fan per unit time (e.g., revolutions per one minute), and k denotes a number of the blades of the fan.

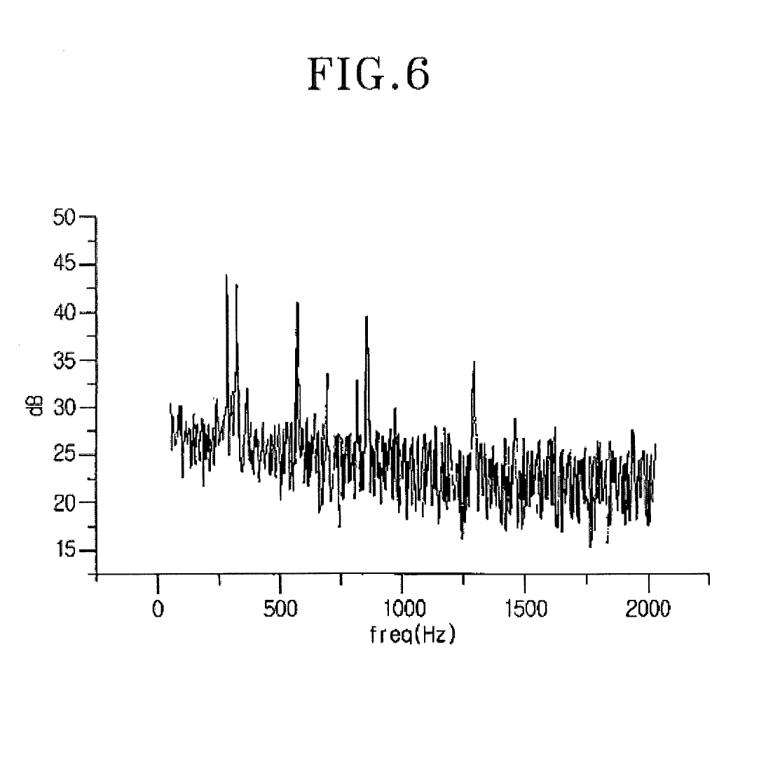

FIG. 6 is a graph showing the noise spectrum properties of the fan. Referring to FIG. 6, a high peak of a sound power is generated in the frequency calculated by the number of revolutions of the fan per unit time and the number of the blades of the fan and a frequency equivalent to an integer multiple of the frequency. For example, when the number of revolutions of the fan per unit time is 2300rpm and the number of the blades of the fan is 7, the noise frequency is 2300×7/(60 sec)=268.33 (Hz). In addition, the sound spectrum has the peak value of 537 Hz and 805 Hz that correspond to the integer multiplies of the noise frequency.

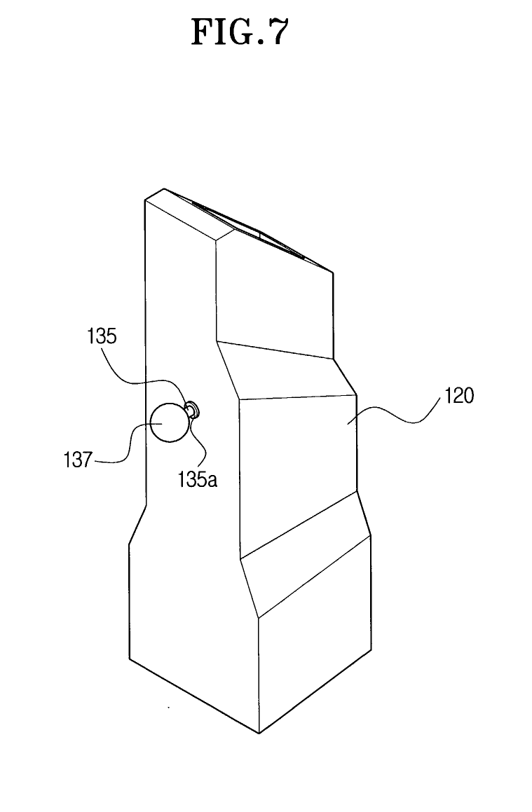

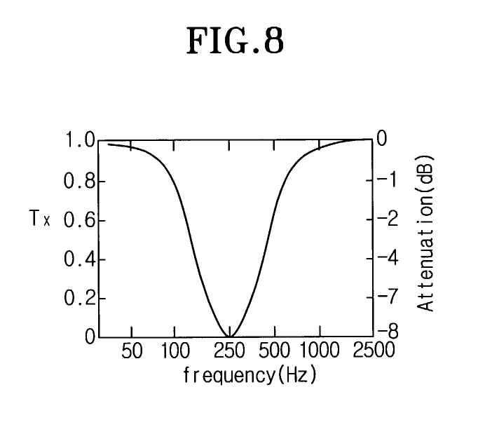

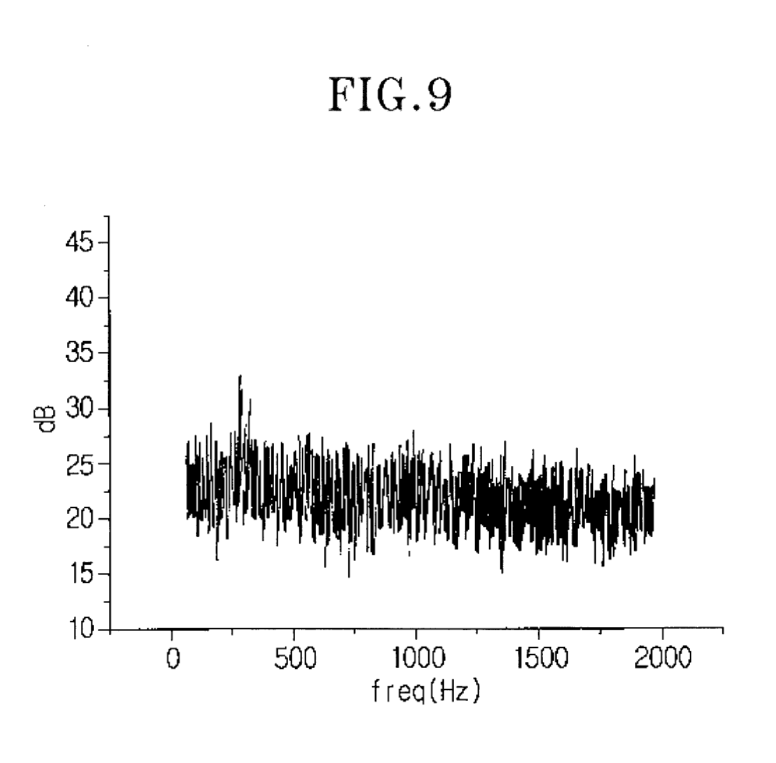

As illustrated in FIG. 7, the resonator 137 installed on the ducts 120 and 130 removes the peak value of the sound spectrum, by resonating at a frequency corresponding to the peak value of the sound spectrum generated by the noise frequency, namely the frequency obtained by multiplying the number of revolutions of the cooling fans 113 and 114 per unit time by the number of the blades of the cooling fans 113 and 114, and the frequency equivalent to an integer multiple of the calculated frequency. In this case, noise attenuation properties of the resonator 137 are shown in FIG. 8, and the sound spectrum having the peak value removed by the resonator 137 is shown in FIG. 9. As illustrated in FIGS. 8 and 9, the noise frequency is removed due to resonation of the resonator 137; specifically, the noise is removed by installing the resonator 137 having an identical frequency to the noise frequency on the duct 120. Accordingly, the resonator 137 removes the peak value of the sound spectrum, so that the projection television can reduce noise that causes displeasure to users.

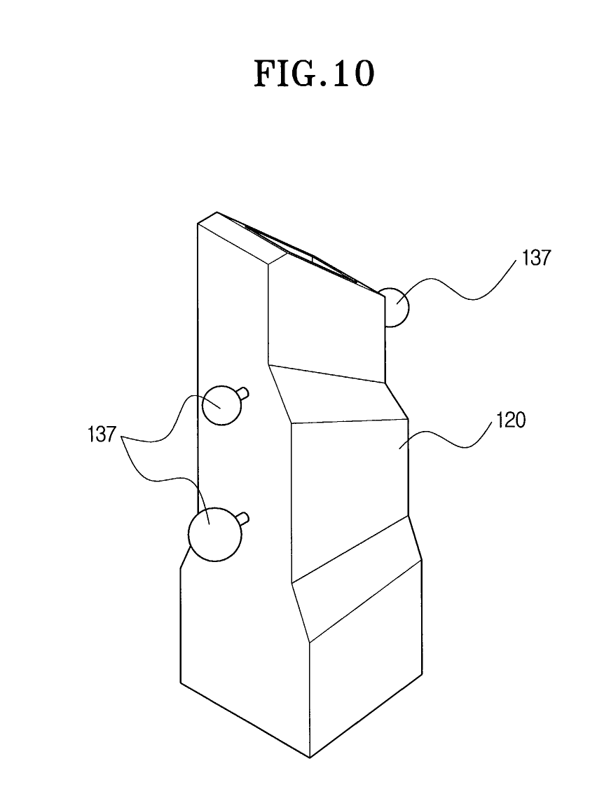

FIG. 10 is a diagram illustrating the structure of FIG. 5 having a plurality of resonators 137 on the ducts 120 and 130. The air sucked into the inlet unit 120a of the duct 120 by the cooling fan 113 is moved to the outlet unit 120b through a flow passage in the duct 120. In this case, the air passing the flow passage in the duct 120 produces friction with the curved portion of the duct 120, thereby generating noise due to the friction.

Referring to FIG. 10, some resonators 137 installed on the ducts 120 and 130 are used to remove the noise corresponding to the peak value of the sound spectrum, by resonating at a frequency obtained by multiplying the number of revolutions of the cooling fans 113 and 114 per unit time by the number of the blades of the cooling fans 113 and 114, and the frequency equivalent to an integer multiple of the calculated frequency.

The other resonators 137 are employed to remove noise generated by friction of the air passing through the duct 120 and the duct 30. In this case, the noise generated by friction of the air passing through the duct 120 and the duct 130 has different peak values of the sound spectrum in every friction portion. Accordingly, the noise generated by the air and the duct 120 as well as the noise generated by the cooling fans 113 and 114 can be removed by installing a plurality of resonators 137 for resonating at the frequency corresponding to the noise generated by friction of the air and the duct 120 to be equalized to a number of the peak values of the sound spectrum for the friction noise.

Therefore, the users of the projection television can watch the television in an environment which does not have the noise generated by the cooling fans and the noise generated by the friction of the air passing through the duct 120 and the duct 130.

In accordance with the present invention, the projection television can reduce the noise generated by the cooling fans, by installing the resonator on the duct that induces the air sucked in by the cooling fans and that externally discharges the air. Moreover, the noise generated due to other factors can also be removed by adjusting the number of the resonators.

Although illustrative embodiments of the present invention has been described, it is understood that the present invention should not be limited to the described illustrative embodiments but various changes and modifications can be made by one skilled in the art within the spirit and scope of the present invention as hereinafter claimed.

What is claimed is:

1. A projection television comprising:
a lamp which provides a light source;
a circuit driving unit which supplies electric power;
a cooling fan which cools heat generated in the lamp and the circuit driving unit;
a duct which induces an air drawn in by the cooling fan, and which externally discharges the air; and
a resonator, installed on the duct, which removes noise generated by the cooling fan.

2. The projection television of claim 1, wherein the resonator removes the noise by resonating at a frequency calculated by multiplying a number of revolutions of the cooling fan per unit time by a number of blades of the cooling fan.

3. The projection television of claim 2, further comprising at least one auxiliary resonator which removes noise by resonating a frequency that corresponds to an integer multiple of the calculated frequency.

4. The projection television of claim 2, wherein the duct is formed in a tube shape, and comprises an inlet unit through which the air passing the lamp and/or the circuit driving unit can be drawn in, and an outlet unit which externally discharges the air.

5. The projection television of claim 4, further comprising at least one friction noise resonator to remove the friction noise on the duct by resonating at a frequency, which corresponds with a friction noise generated by a friction of the air and the duct.

6. A method for reducing noise in a projection television, comprising:
calculating a noise frequency of a cooling fan by multiplying a number of revolutions per unit of time by a number of blades in the cooling fan;
calculating an intrinsic frequency of a resonator using a spring and a mass, by applying the formula of:
$$ω = \sqrt{\frac{{C}^{2} S}{{L}^{′} V}}$$
wherein, C denotes a sound velocity, S denotes a section of a neck of the resonator, L′ denotes an equivalent length of the neck of the resonator connected by a flange, and V denotes a bulk of the resonator; and
resonating the resonator located on a duct, at the intrinsic frequency equivalent to a peak value of the noise frequency.

7. The method for reducing noise in a projection television according to claim 6, wherein the step of resonating includes using a plurality of the resonators, which removes noise made by the fan and noise made by a friction of air and the duct.

8. A projection television comprising:
a lamp which provides a light source;
a circuit driving unit which supplies electric power;
a cooling fan which cools heat generated in the lamp and the circuit driving unit;
a duct which induces an air drawn in by the cooling fan, and which externally discharges the air;
a plurality of resonators, installed on the duct, which remove noise generated by the cooling fan and noise generated by the friction of air and the duct.

9. The projection television of claim 8, wherein the resonators remove the noise of the cooling fans by resonating at a frequency calculated by multiplying a number of revolutions of the cooling fan per unit time by a number of blades of the cooling fan.

10. The projection television of claim 9, wherein the duct is a spherical chamber, which comprises an inlet unit through which the air passing the lamp and/or the circuit driving unit can be drawn in, and an outlet unit which externally discharges the air.

11. The projection television of claim 10, further comprising at least one friction noise resonator to remove the friction noise on the duct by resonating at a frequency, which corresponds with the friction noise generated by the friction of the air and the duct.

12. The projection television of claim 8, further comprising image display reflecting mirrors and a projection lens, which are positioned between the lamp and the circuit driving unit.
